(19) United States
(12) Patent Application Publication
(10) Pub. No.: US 2013/0122288 A1
(43) Pub. Date: May 16, 2013

(54) PRESSURE-SENSITIVE ADHESIVE COMPOSITION AND PRESSURE-SENSITIVE ADHESIVE SHEET

(71) Applicant: Nitto Denko Corporation, Ibaraki-shi (JP)

(72) Inventors: Kaori Miki, Ibaraki-shi (JP); Masahito Niwa, Ibaraki-shi (JP); Takahiro Nonaka, Ibaraki-shi (JP); Masato Fujita, Ibaraki-shi (JP)

(73) Assignee: NITTO DENKO CORPORATION, Ibaraki-shi (JP)

(21) Appl. No.: 13/672,938

(22) Filed: Nov. 9, 2012

(30) Foreign Application Priority Data
Nov. 10, 2011 (JP) 2011-246877
Jan. 23, 2012 (JP) 2012-010895

(51) Int. Cl. C09J 133/04; C09J 7/00

(52) U.S. Cl. CPC C09J 133/04; C09J 7/00
USPC 428/343; 526/263; 526/264; 526/307.7; 526/320; 526/323.2

(57) ABSTRACT

Disclosed is a pressure-sensitive adhesive composition capable of forming a pressure-sensitive adhesive layer having satisfactory tackiness at room temperature and superior reworkability at a low temperature. The pressure-sensitive adhesive composition includes an acrylic polymer formed from a monomer component through polymerization, or a partial polymer of the monomer component. The monomer component includes a (meth)acrylic alkyl ester whose alkyl moiety being a linear or branched-chain alkyl group having 10 to 13 carbon atoms and includes substantially no carboxyl-containing monomer.

### TECHNICAL FIELD

The present invention relates to a pressure-sensitive adhesive composition. Specifically, the present invention relates to a pressure-sensitive adhesive composition capable of forming a pressure-sensitive adhesive layer which is particularly preferably used for the lamination of optical members and the production of optical products. The present invention also relates to a pressure-sensitive adhesive sheet having a pressure-sensitive adhesive layer formed from the pressure-sensitive adhesive composition.

### BACKGROUND ART

Liquid crystal displays (LCDs) and other display devices, as well as touch-screen panels and other input devices to be used in combination with the display devices, have been widely employed in various areas. Transparent pressure-sensitive adhesive sheets are used for the lamination of optical members to produce such display devices and input devices. For example, transparent pressure-sensitive adhesive sheets are used for the lamination of touch-screen panels or lenses with display devices (e.g., LCDs) (see, for example, Patent Literature (PTL) 1, PTL 2, and PTL 3).

### CITATION LIST

### Patent Literature

PTL 1: Japanese Unexamined Patent Application Publication (JP-A) No. 2003-238915
PTL 2: JP-A No. 2003-342542
PTL 3: JP-A No, 2004-231723

### SUMMARY OF INVENTION

### Technical Problem

Pressure-sensitive adhesive sheets for use in the above applications have been more and more demanded to have removability (reworkability), particularly removability (reworkability) at a low temperature, when rebonding (relamination) of optical members is required after the lamination of the optical members with each other. However, the customary pressure-sensitive adhesive sheets, particularly pressure-sensitive adhesive layers, do not provide easy reworking particularly when they are used for the lamination of highly rigid optical members with each other, thus failing to satisfy the requirement sufficiently.

Of optical members, those including members having steps or bumps such as printed-ink bumps are increasing in number. Typically, a lens member bearing a frame-like printed region may be laminated on a liquid crystal display device by the medium of a double-coated pressure-sensitive adhesive sheet. Pressure-sensitive adhesive sheets, particularly pressure-sensitive adhesive layers, for use in such application require a capability of filling in bumps such as printed-ink bumps, namely, excellent bump absorptivity (also referred to as “bump conformability”).

The reworkability is desired not only in lamination of optical members but also in other various uses.

Accordingly, an object of the present invention is to provide a pressure-sensitive adhesive composition capable of forming a pressure-sensitive adhesive layer which has satisfactory tackiness at room temperature and excellent reworkability at a low temperature.

### Solution to Problem

After intensive investigations, the present inventors have found that a pressure-sensitive adhesive sheet excels in reworkability, bump absorptivity, and less-corroding property when having a pressure-sensitive adhesive layer formed from a pressure-sensitive adhesive composition including an acrylic polymer with a specific formulation. The present invention has been made based on these findings.

Specifically, the present invention provides a pressure-sensitive adhesive composition which contains an acrylic polymer formed from a monomer component through polymerization, or a partial polymer of the monomer component, in which the monomer component includes a (meth)acrylic alkyl ester whose alkyl moiety being a linear or branched-chain alkyl group having 10 to 13 carbon atoms, and the monomer component contains substantially no carboxyl-containing monomer.

The monomer component preferably further includes a polar-group-containing monomer.

The polar-group-containing monomer is preferably at least one selected from the group consisting of hydroxyl-containing monomers and nitrogen-containing monomers.

The monomer component preferably further includes a (meth)acrylic alkyl ester whose alkyl moiety being a linear or branched-chain alkyl group having 1 to 9 carbon atoms.

The monomer component preferably further includes a (meth)acrylic ester having an alicyclic hydrocarbon group.

The (meth)acrylic alkyl ester whose alkyl moiety being a linear or branched-chain alkyl group having 10 to 13 carbon atoms is preferably lauryl acrylate.

The present invention also provides a pressure-sensitive adhesive sheet having a pressure-sensitive adhesive layer formed from the pressure-sensitive adhesive composition.

The pressure-sensitive adhesive layer preferably contains the acrylic polymer in a content of 50 percent by weight or more.

The pressure-sensitive adhesive sheet is preferably an optical pressure-sensitive adhesive sheet.

The present invention further provides an optical double-coated pressure-sensitive adhesive sheet having an adhesive strength at −30° C. of less than 20 N in a delamination test mentioned below and having a 180-degree peel strength at 23° C. of 2.0 N/20 mm or more on at least one adhesive face thereof, the 180-degree peel strength being determined with respect to glass at a tensile speed of 300 mm/min:

Delamination Test: One adhesive face of a double-coated pressure-sensitive adhesive sheet (size: 26 mm long by 30 mm wide) is affixed to a surface of an after-mentioned adherend A and the other adhesive face is affixed to a surface of an after-mentioned adherend B to give a test piece having a structure of (adherend A)/(double-coated pressure-sensitive adhesive sheet)/(adherend B); the test piece is treated at a temperature of 50° C. and a pressure of 5 atmospheres for 15 minutes and left stand at an ambient temperature of −30° C. for 30 minutes; while the adherend A is fixed, the adherend B is pulled in a thickness direction at a tensile speed of 300 mm/min; and a maximum load at which the adherend A and the adherend B are detached from each other is measured as the adhesive strength at −30° C.

Adherend A: Glass plate (Matsunami Glass Ind., Ltd., 0.7 mm thick, size: 100 mm long by 50 mm wide)

Adherend B: Glass slide (Matsunami Glass Ind., Ltd., 1.0 mm thick, size: 76 mm long by 26 mm wide)

In addition and advantageously, the present invention provides a double-coated pressure-sensitive adhesive sheet allowing the adherend A and the adherend B to be detached from each other without fracture or breakage in the delamination test.

### Advantageous Effects of Invention

A pressure-sensitive adhesive composition according to an embodiment of the present invention has the above configuration and is thereby capable of forming a pressure-sensitive adhesive layer which has satisfactory tackiness at room temperature and excellent reworkability at a low temperature. A pressure-sensitive adhesive sheet according to another embodiment of the present invention having a pressure-sensitive adhesive layer formed from the pressure-sensitive adhesive composition has satisfactory tackiness at room temperature and excellent reworkability at a low temperature. The pressure-sensitive adhesive sheet is therefore useful particularly as an optical pressure-sensitive adhesive sheet for the lamination of optical members and the production of optical members and optical products.

These and other objects, features, and advantages of the present invention will be more fully understood from the following description of embodiments with reference to the attached drawings. All numbers are herein assumed to be modified by the term “about.”

### BRIEF DESCRIPTION OF DRAWINGS

FIG. 1 is a schematic diagram as a plan view illustrating a test sample for the evaluation of reworkability in working examples; and

FIG. 2 is a schematic diagram as a cross-sectional view taken along the line A-A in FIG. 1, illustrating the test sample for the evaluation of reworkability in the working examples, on which a kite string is hooked.

### DESCRIPTION OF EMBODIMENTS

### Pressure-Sensitive Adhesive Composition

A pressure-sensitive adhesive composition according to an embodiment of the present invention includes an acrylic polymer formed from a monomer component through polymerization, or a partial polymer of the monomer component. The pressure-sensitive adhesive composition may further include any of a polymerization initiator, a crosslinking agent, a solvent, and other additives according to necessity, as described below.

As used herein the term “(meth)acrylic” refers to “acrylic” and/or “methacrylic” (either “acrylic” or “methacrylic,” or both), and the same is true for other descriptions.

Also as used herein the term “alkyl group” refers to a linear or branched chain alkyl group, unless otherwise specified.

The monomer component may be a monomer of a single type or a mixture of monomers of two or more different types.

A pressure-sensitive adhesive composition including a partial polymer of the monomer component is typified by a so-called active-energy-ray-curable pressure-sensitive adhesive composition. A pressure-sensitive adhesive composition essentially including an acrylic polymer obtained through polymerization of the monomer component is typified by a so-called solvent-borne pressure-sensitive adhesive composition.

The term “partial polymer of (the) monomer component” refers to a substance obtained through partial polymerization of one or more components constituting the monomer component. Specifically, the “partial polymer of (the) monomer component” may for example be a mixture of a monomer component with a partial polymer of the monomer component.

Acrylic Polymer

The acrylic polymer is not limited, but may be typified by acrylic polymers each obtained through polymerization of a monomer component including a (meth)acrylic alkyl ester whose alkyl moiety being an alkyl group having 8 to 24 carbon atoms (hereinafter also referred to as “(meth)acrylic C₈-C₂₄ alkyl ester”).

More specifically, of such (meth)acrylic C₈-C₂₄ alkyl esters, (meth)acrylic alkyl esters whose alkyl moiety having 10 to 18 carbon atoms are preferred; (meth)acrylic alkyl esters whose alkyl moiety having 10 to 16 carbon atoms are more preferred; and (meth)acrylic alkyl esters whose alkyl moiety having 10 to 13 are particularly preferred.

The (meth)acrylic C₈-C₂₄ alkyl ester is not limited, but may be typified by octyl(meth)acrylate, 2-ethylhexyl(meth)acrylate, isooctyl(meth)acrylate, nonyl(meth)acrylate, isononyl(meth)acrylate, decyl(meth)acrylate, isodecyl(meth)acrylate, undecyl(meth)acrylate, dodecyl(meth)acrylate, tridecyl(meth)acrylate, tetradecyl(meth)acrylate, pentadecyl(meth)acrylate, isopentadecyl(meth)acrylate, hexadecyl(meth)acrylate, isohexadecyl(meth)acrylate, heptadecyl(meth)acrylate, isoheptadecyl(meth)acrylate, octadecyl(meth)acrylate, isooctadecyl(meth)acrylate, docosyl(meth)acrylate, isodocosyl(meth)acrylate, tetracosyl(meth)acrylate, and isotetracosyl(meth)acrylate. Among them, preferred are decyl(meth)acrylate, isodecyl(meth)acrylate, undecyl(meth)acrylate, dodecyl(meth)acrylate, and tridecyl(meth)acrylate; of which dodecyl acrylate (lauryl acrylate) is more preferred.

Each of different (meth)acrylic C₈-C₂₄ alkyl esters may be used alone or in combination.

The monomer component preferably further includes a (meth)acrylic alkyl ester whose alkyl moiety having 1 to 9 carbon atoms (hereinafter also referred to as a “(meth)acrylic C₁-C₉ alkyl ester”) and/or a (meth)acrylic ester having an alicyclic hydrocarbon group (hereinafter also referred to as an “alicyclic monomer”).

The (meth)acrylic C₁-C₉ alkyl ester is not limited, but may be typified by methyl(meth)acrylate, ethyl(meth)acrylate, propyl(meth)acrylate, isopropyl(meth)acrylate, n-butyl(meth)acrylate, isobutyl(meth)acrylate, s-butyl(meth)acrylate, t-butyl(meth)acrylate, pentyl(meth)acrylate, isopentyl(meth)acrylate, hexyl(meth)acrylate, heptyl(meth)acrylate, octyl(meth)acrylate, 2-ethylhexyl(meth)acrylate, isooctyl(meth)acrylate, nonyl(meth)acrylate, and isononyl(meth)acrylate. Among them, preferred are (meth)acrylic alkyl esters whose alkyl moiety being a linear or branched-chain alkyl group having 1 to 6 carbon atoms; of which methyl(meth)acrylate and n-butyl(meth)acrylate are more preferred, and methyl acrylate and n-butyl acrylate are furthermore preferred.

Each of different (meth)acrylic C₁-C₉ alkyl esters may be used alone or in combination.

The alicyclic monomer is a monomer serving as an alicyclic compound, i.e., a monomer having a non-aromatic ring in the molecule. The non-aromatic ring is typified by non-aromatic alicyclic rings (e.g., cycloalkane rings such as cyclopentane ring, cyclohexane ring, cycloheptane ring, and cyclooctane ring; and cycloalkene rings such as cyclohexene ring), non-aromatic bridged rings (e.g., bridged hydrocarbon rings including bicyclic hydrocarbon rings typically in pinane, pinene, bornane, norbornane, and norbornene; tricyclic hydrocarbon rings typically in adamantane; and tetracyclic hydrocarbon rings).

The alicyclic monomer is not limited, but may be typified by (meth)acrylic cycloalkyl esters such as cyclopentyl(meth)acrylate, cyclohexyl(meth)acrylate, cycloheptyl(meth)acrylate, and cyclooctyl(meth)acrylate; (meth)acrylic esters having a bicyclic hydrocarbon ring, such as bornyl(meth)acrylate, isobornyl(meth)acrylate, dicyclopentanyl(meth)acrylate and dicyclopentanyloxyethyl(meth)acrylate; and (meth)acrylic esters each having a tricyclic or higher hydrocarbon ring, such as tricyclopentanyl(meth)acrylate, 1-adamantyl(meth)acrylate, 2-methyl-2-adamantyl(meth)acrylate, and 2-ethyl-2-adamantyl(meth)acrylate.

Each of different alicyclic monomers may be used alone or in combination.

The alicyclic monomer is preferably any of cyclohexyl acrylate (CHA), cyclohexyl methacrylate (CHMA), isobornyl acrylate (IBXA), and isobornyl methacrylate (IBXMA).

The monomer component preferably includes substantially no carboxyl-containing monomer. The phrase “including substantially no” refers to that the substance in question is not actively added, except for the case of inevitable contamination. Specifically, the monomer component may have a content of carboxyl-containing monomer of less than 0.05 percent by weight, preferably less than 0.01 percent by weight, and furthermore preferably less than 0.001 percent by weight, based on the total amount (100 percent by weight) of the monomer component.

The carboxyl-containing monomer may be exemplified by acrylic acid (AA), methacrylic acid, itaconic acid, maleic acid, fumaric acid, and crotonic acid. As used herein the term “carboxyl-containing monomer” also includes acid anhydrides of these carboxyl-containing monomers, such as maleic anhydride, itaconic anhydride, and other monomers containing an acid anhydride group.

The monomer component preferably further includes a polar-group-containing monomer. A polar-group-containing monomer has an appropriate polarity and, when included in the monomer component, allows the pressure-sensitive adhesive composition to give a pressure-sensitive adhesive layer which exhibits an appropriate adhesive strength.

The polar-group-containing monomer is a monomer having a polar group in the molecule. Of such polar-group-containing monomers, ethylenically unsaturated monomers are preferred. As used herein the term “polar-group-containing monomer” refers to any of polar-group-containing monomers other than carboxyl-containing monomers, i.e., any of monomers having a polar group other than carboxyl group in the molecule.

The polar-group-containing monomer is not limited, but may be typified by hydroxyl-containing monomers including hydroxyalkyl(meth)acrylates such as 2-hydroxyethyl(meth)acrylate, 3-hydroxypropyl(meth)acrylate, 4-hydroxybutyl(meth)acrylate, and 6-hydroxyhexyl(meth)acrylate, as well as vinyl alcohol and allyl alcohol; amido-containing monomers such as (meth)acrylamide, N,N-dimethyl(meth)acrylamide, N-methylol(meth)acrylamide, N-methoxymethyl(meth)acrylamide, N-butoxymethyl(meth)acrylamide, and N-hydroxyethyl(moth)acrylamide; amino-containing monomers such as aminoethyl(meth)acrylate, dimethylaminoethyl(meth)acrylate, and t-butylaminoethyl(meth)acrylate; epoxy-containing monomers such as glycidyl(meth)acrylate and methylglycidyl(meth)acrylate; cyano-containing monomers such as acrylonitrile and methacrylonitrile; heterocycle-containing vinyl monomers such as N-vinyl-2-pyrrolidone, N-vinylcaprolactam, (meth)acryloylmorpholine, N-vinylpyridine, N-vinylpiperidone, N-vinylpyrimidine, N-vinylpiperazine, N-vinylpyrrole, N-vinylimidazole, and N-vinyloxazole; sulfo-containing monomers such as sodium vinylsulfonate; phosphate-containing monomers such as 2-hydroxyethylacryloyl phosphate; imido-containing monomers such as cyclohexylmaleimide and isopropylmaleimide; and isocyanate-containing monomers such as 2-methacryloyloxyethyl isocyanate.

Each of different polar-group-containing monomers may be used alone or in combination.

The polar-group-containing monomer is preferably, but not limited to, a hydroxyl-containing monomer and/or a nitrogen-containing monomer, and more preferably a nitrogen-containing monomer, for protecting the pressure-sensitive adhesive layer from having an excessively increased adhesive strength with time. The nitrogen-containing monomer is a monomer having at least one nitrogen atom per molecule. Examples of the nitrogen-containing monomers include, of the amido-containing monomer and the heterocycle-containing vinyl monomers, those containing at least one nitrogen atom; of which N-vinyl-2-pyrrolidone (NVP), N-vinylcaprolactam (NVC), and N,N-dimethylacrylamide (DMAA) are preferred. The hydroxyl-containing monomer is preferably, but not limited to, 2-hydroxyethyl acrylate.

The monomer component may further include a multifunctional monomer.

The multifunctional monomer is not limited, but may be typified by hexanediol di(meth)acrylates (e.g., 1,6-hexanediol di(meth)acrylate), butanediol di(meth)acrylates, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate (tetramethylolmethane tri(meth)acrylate), dipentaerythritol hexa(meth)acrylate, trimethylolpropane tri(meth)acrylate, allyl(meth)acrylate, vinyl(meth)acrylate, divinylbenzene, epoxy acrylates, polyester acrylates, and urethane acrylates. Among them, 1,6-hexanediol diacrylate (HDDA) is preferred.

Each of different multifunctional monomers may be used alone or in combination.

The monomer component may further include one or more monomers (additional monomers) other than the (meth)acrylic C₈-C₂₄ alkyl esters, the (meth)acrylic C₁-C₉ alkyl esters, the alicyclic monomers, the polar-group-containing monomers, and the multifunctional monomers.

Exemplary additional monomers include (meth)acrylic esters other than the (meth)acrylic C₈-C₂₄ alkyl esters, the (meth)acrylic C₁-C₉ alkyl esters, the alicyclic monomers, the polar-group-containing monomers, and the multifunctional monomers, which are typified by (meth)acrylic esters having an aromatic hydrocarbon group, such as phenyl(meth)acrylate, phenoxyethyl(meth)acrylate, and benzyl(meth)acrylate; and (meth)acrylic alkoxyalkyl esters such as methoxyethyl(meth)acrylate and ethoxyethyl(meth)acrylate. Exemplary additional monomers further include vinyl esters such as vinyl acetate and vinyl propionate; aromatic vinyl compounds such as styrene and vinyltoluenes; olefins or dienes such as ethylene, butadiene, isoprene, and isobutylene; vinyl ethers such as vinyl alkyl ethers; and vinyl chloride.

Each of different additional monomers may be used alone or in combination.

Though not critical, the monomer component may have a content of a (meth)acrylic C₈-C₂₄ alkyl ester or esters of preferably 45 to 100 percent by weight, more preferably 50 to 95 percent by weight, and furthermore preferably 60 to 90 percent by weight, based on the total amount (100 percent by weight) of the monomer component. The monomer component, when having a content of (meth)acrylic C₈-C₂₄ alkyl ester(s) of 45 percent by weight or more, may give, through polymerization, an acrylic polymer having superior reworkability at a low temperature (about −60° C. to about 20° C.).

The monomer component may have a content of a (meth)acrylic C₁-C₉ alkyl ester or esters, when included, of not critical, but preferably more than 0 percent by weight and less than or equal to 50 percent by weight, more preferably 5 to 35 percent by weight, and furthermore preferably 10 to 25 percent by weight, based on the total amount (100 percent by weight) of the monomer component. The monomer component, when having a content of (meth)acrylic C₁-C₉ alkyl ester(s) of 50 percent by weight or less, may give an acrylic polymer having a more appropriate modulus of elasticity and exhibiting a higher adhesive strength at room temperature (about 23° C.).

The monomer component may have a content of an alicyclic monomer or monomers, when included, of not critical, but preferably more than 0 percent by weight and less than or equal to 50 percent by weight, more preferably 5 to 35 percent by weight, furthermore preferably 8 to 30 percent by weight, and particularly preferably 10 to 25 percent by weight, based on the total amount (100 percent by weight) of the monomer component. The monomer component, when having a content of alicyclic monomer(s) of 50 percent by weight or less, may give an acrylic polymer having a more appropriate modulus of elasticity and exhibiting a higher adhesive strength at room temperature (about 23° C.).

Particularly when including both a (meth)acrylic C₁-C₉ alkyl ester(s) and an alicyclic monomer(s), the monomer component may have a total content of these monomers of preferably more than 0 percent by weight and less than or equal to 50 percent by weight, more preferably 5 to 35 percent by weight, furthermore preferably 8 to 30 percent by weight, and particularly preferably 10 to 25 percent by weight, based on the total amount (100 percent by weight) of the monomer component.

The monomer component may have a content of a polar-group-containing monomer or monomers, when included, of not critical, but preferably more than 0 percent by weight and less than or equal to 20 percent by weight, more preferably 2 to 10 percent by weight, and furthermore preferably 3 to 8 percent by weight, based on the total amount (100 percent by weight) of the monomer component. The monomer component, when having a content of polar-group-containing monomer(s) of 20 percent by weight or less, may give an acrylic polymer protected from having an excessively increased adhesive strength with time. The monomer component more preferably has a total sum of the content of hydroxyl-containing monomers and the content of nitrogen-containing monomers (total content) falling within the above-specified range.

The monomer component may have a content of a multifunctional monomer or monomers, when included, of not critical, but preferably more than 0 percent by weight and less than or equal to 1 percent by weight, more preferably 0.02 to 0.1 percent by weight, and furthermore preferably 0.03 to 0.08 percent by weigh, based on the total amount (100 percent by weight) of the monomer component. This may give, through polymerization, an acrylic polymer which has a gel fraction controlled within a preferred range. The monomer component, when having a content of multifunctional monomer(s) of 1 percent by weight or less, may give, through polymerization, an acrylic polymer which may be protected from having an excessively high gel fraction and which may advantageously help a pressure-sensitive adhesive layer including the acrylic polymer to have better bump absorptivity.

The pressure-sensitive adhesive composition, when containing a crosslinking agent, does not have to employ the multifunctional monomer(s) in the monomer component, but the composition, when containing no crosslinking agent, preferably employs the multifunctional monomer(s) in the monomer component in a content within the above-specified range.

In other words, an acrylic polymer obtained through polymerization of the monomer component (hereinafter also simply referred to as “acrylic polymer”) includes at least constitutional units derived from a (meth)acrylic C₈-C₂₄ alkyl ester. The acrylic polymer preferably includes substantially no constitutional unit derived from a carboxyl-containing monomer. The acrylic polymer preferably further includes constitutional units derived from a (meth)acrylic C₁-C₉ alkyl ester and/or constitutional units derived from an alicyclic monomer. The acrylic polymer preferably further includes constitutional units derived from a polar-group-containing monomer. The acrylic polymer may include any of constitutional units derived from a multifunctional monomer and constitutional units derived from an additional monomer. Constitutional units of each category may be those of a single type or those of two or more different types.

Though not critical, the acrylic polymer may have a content of constitutional units derived from a (meth)acrylic C₈-C₂₄ alkyl ester(s) of preferably 45 to 100 percent by weight, more preferably 50 to 95 percent by weight, and furthermore preferably 60 to 90 percent by weight, based on the total amount (100 percent by weight) of the acrylic polymer. The acrylic polymer may have a content of constitutional units derived from a (meth)acrylic C₁-C₉ alkyl ester(s), when included, of preferably more than 0 percent by weight and less than or equal to 50 percent by weight, more preferably 5 to 35 percent by weight, and furthermore preferably 10 to 25 percent by weight. The acrylic polymer may have a content of constitutional units derived from an alicyclic monomer(s), when included, of preferably more than 0 percent by weight and less than or equal to 50 percent by weight, more preferably 5 to 35 percent by weight, furthermore preferably 8 to 30 percent by weight, and particularly preferably 10 to 25 percent by weight. The acrylic polymer may have a total content of constitutional units derived from a (meth)acrylic C₁-C₉ alkyl ester(s) and constitutional units derived from an alicyclic monomer(s), when both included, of preferably more than 0 percent by weight and less than or equal to 50 percent by weight, more preferably 5 to 35 percent by weight, furthermore preferably 8 to 30 percent by weight, and particularly preferably 10 to 25 percent by weight. The acrylic polymer may have a content of constitutional units derived from a polar-group-containing monomer(s), when included, of preferably more than 0 percent by weight and less than or equal to 20 percent by weight, more preferably 2 to 10 percent by weight, and furthermore preferably 3 to 8 percent by weight. The acrylic polymer may have a content of constitutional units derived from a multifunctional monomer(s), when included, of preferably more than 0 percent by weight and less than or equal to 1 percent by weight, more preferably 0.02 to 0.1 percent by weight, and furthermore preferably 0.03 to 0.08 percent by weight.

The pressure-sensitive adhesive composition, in a preferred embodiment of the present invention, is a pressure-sensitive adhesive composition including an acrylic polymer obtained through polymerization of a monomer component, or a partial polymer of the monomer component, in which the monomer component essentially includes a (meth)acrylic alkyl ester whose alkyl moiety having 10 to 13 carbon atoms (hereinafter also referred to as a “(meth)acrylic C₁₀-C₁₃ alkyl ester”) and includes substantially no carboxyl-containing monomer.

The pressure-sensitive adhesive composition according to the embodiment, in which the material monomer component includes a (meth)acrylic alkyl ester whose alkyl moiety having 10 to 13 carbon atoms, has satisfactory tackiness at room temperature, but exhibits a low adhesive strength and becomes easily peelable (removable) at a low temperature (about −60° C. to about 20° C.), and thereby has more superior reworkability at a low temperature.

The acrylic polymer obtained through polymerization of the monomer component employs a (meth)acrylic C₁₀-C₁₃ alkyl ester as an essential monomer component and thereby has side chain crystallinity, in which side chains of constitutional units derived from the (meth)acrylic C₁₀-C₁₃ alkyl ester are crystallized. Crystals formed from the side chains probably have crystal melting temperatures of about −60° C. to about 20° C. Owing to this, the acrylic polymer is non-crystalline at room temperature (about 23° C.), but undergoes crystallization of side chains of constitutional units derived from the (meth)acrylic C₁₀-C₁₃ alkyl ester at a low temperature (about −60° C. to about 20° C.). The acrylic polymer derived from a (meth)acrylic C₁₀-C₁₃ alkyl ester as an essential monomer component therefore has satisfactory tackiness at room temperature, but, at a low temperature, has a higher modulus of elasticity, exhibits a low adhesive strength, becomes more easily removable, and exhibits superior reworkability.

Pressure-sensitive adhesive sheets, particularly pressure-sensitive adhesive layers, when applied to an adherend made of a metal or metal oxide (e.g., a transparent conductive layer of a transparent conductive film such as an indium-tin-oxide (ITO) film), may require such a property as not to cause corrosion on the adherend (this property is also referred to as “less-corroding property”). With expanding uses of display devices and input devices, pressure-sensitive adhesive sheets, particularly pressure-sensitive adhesive layers, for use in such devices should exhibit sufficient properties as pressure-sensitive adhesive sheets in a wide variety of environments. Typically, they may require blistering/separation resistance so as not to suffer from blistering and separation in a high-temperature environment or a high-temperature and high-humidity environment. The bump absorptivity, less-corroding property, and blistering/separation resistance are required not only in lamination with optical members but also in various other uses.

The pressure-sensitive adhesive composition according to the embodiment employs a (meth)acrylic C₁₀-C₁₃ alkyl ester as an essential component in the monomer component and may include, through polymerization of the monomer component, an acrylic polymer appropriately soft (flexible) at room temperature. This may give a pressure-sensitive adhesive sheet which can easily conform to bumps and exhibits superior bump absorptivity even when applied to a member having bumps, such as a glass plate having printed-ink bumps.

The pressure-sensitive adhesive composition according to the embodiment employs substantially no carboxyl-containing monomer in the monomer component and gives a pressure-sensitive adhesive sheet which does not corrode an adherend and which has excellent less-corroding property even when applied to an adherend transparent conductive layer containing a metal or metal oxide, such as an ITO film. The pressure-sensitive adhesive sheet also has superior bump absorptivity at room temperature and less suffers from an increasing adhesive strength with time. Specifically, an acrylic polymer obtained through polymerization of such monomer component including substantially no carboxyl-containing monomer may exhibit further better less-corroding property, have more stable and better bump absorptivity at room temperature by the action of the acrylic polymer, and/or enable more stable detachment (removal).

The pressure-sensitive adhesive composition according to the embodiment, when further including a (meth)acrylic C₁-C₉ alkyl ester and/or an alicyclic monomer in the monomer component, may give a pressure-sensitive adhesive layer which has a higher cohesive force and a higher modulus of elasticity at room temperature, has further better blistering/separation resistance, and can be handled more easily.

The use of a monomer component essentially including a (meth)acrylic alkyl ester whose alkyl moiety having 10 to 13 carbon atoms is described above as an illustrative embodiment. It should be noted, however, the embodiment is not intended to limit the scope of the present invention. Typically, instead of using a (meth)acrylic alkyl ester whose alkyl moiety having 10 to 13 carbon atoms, a pressure-sensitive adhesive composition can provide satisfactory reworkability as above, by employing a (meth)acrylic alkyl ester whose alkyl moiety having 1 to 9 carbon atoms and a (meth)acrylic alkyl ester whose alkyl moiety having 14 to 24 carbon atoms in combination in the monomer component.

Polymerization Process to Form Acrylic Polymer

Such acrylic polymer obtained through polymerization of the monomer component may be prepared by polymerizing the monomer component or a partial polymer of the monomer component (e.g., a mixture of a monomer component with a partial polymer of the monomer component) according to a known or customary polymerization process.

Exemplary polymerization processes of the monomer component or a partial polymer of the monomer component include solution polymerization, emulsion polymerization, bulk polymerization, and polymerization upon application of heat or an active energy ray (thermal polymerization or active-energy-ray-polymerization). Among them, solution polymerization and active-energy-ray-polymerization are preferred for satisfactory transparency, waterproof, and cost. Though not limited, the monomer component or a partial polymer of the monomer component is preferably prevented from being in contact with oxygen during polymerization. For example, polymerization under a nitrogen atmosphere is preferred.

Exemplary active energy rays to be applied upon the active-energy-ray-polymerization (photopolymerization) include ionizing radiation such as alpha rays, beta rays, gamma rays, neutron beams, and electron beams; and ultraviolet rays, of which ultraviolet rays are preferred. Conditions for the active energy ray irradiation, such as irradiation energy, irradiation time, and irradiation procedure, are not limited, as long as a photoinitiator is activated to induce a reaction of a monomer component.

The solution polymerization may employ a solvent of every kind. The solvent herein is typified by organic solvents including esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone. Each of different solvents may be used alone or in combination.

The polymerization of a monomer component or a partial polymer of the monomer component may employ any of polymerization initiators such as photoinitiators (photopolymerization initiators) and thermal initiators, depending on the type of the polymerization reaction. Each of different polymerization initiators may be used alone or in combination.

The photoinitiators are not limited, but may be typified by benzoin ether photoinitiators, acetophenone photoinitiators, α-ketol photoinitiators, aromatic sulfonyl chloride photoinitiators, photoactive oxime photoinitiators, benzoin photoinitiators, benzil photoinitiators, benzophenone photoinitiators, ketal photoinitiators, and thioxanthone photoinitiators. Though not critical, such photoinitiator(s) may be used in an amount of preferably 0.01 to 1 part by weight, and more preferably 0.05 to 0.5 part by weight, per 100 parts by weight of the total amount of the monomer component.

The benzoin ether photoinitiators are exemplified by benzoin methyl ether, benzoin ethyl ether, benzoin propyl ether, benzoin isopropyl ether, benzoin isobutyl ether, and 2,2-dimethoxy-1,2-diphenylethan-1-one. The acetophenone photoinitiators are typified by 2,2-diethoxyacetophenone, 2,2-dimethoxy-2-phenylacetophenone, 1-hydroxycyclohexyl phenyl ketone (α-hydroxycyclohexyl phenyl ketone), 4-phenoxydichloroacetophenone, and 4-(t-butyl)dichloroacetophenone. The α-ketol photoinitiators are typified by 2-methyl-2-hydroxypropiophenone and 1-[4-(2-hydroxyethyl)phenyl]-2-methylpropan-1-one. The aromatic sulfonyl chloride photoinitiators are typified by 2-naphthalenesulfonyl chloride. The photoactive oxime photoinitiators are typified by 1-phenyl-1,1-propanedione-2-(o-ethoxycarbonyl)oxime.

The benzoin photoinitiators include benzoin. The benzil photoinitiators include benzil. The benzophenone photoinitiators are exemplified by benzophenone, benzoylbenzoic acid, 3,3′-dimethyl-4-methoxybenzophenone and polyvinylbenzophenone. The ketal photoinitiators include benzyl dimethyl ketal. The thioxanthone photoinitiators are typified by thioxanthone, 2-chlorothioxanthone, 2-methylthioxanthone, 2,4-dimethylthioxanthone, isopropylthioxanthone, 2,4-diisopropylthioxanthone, and dodecylthioxanthone.

Polymerization initiators for use in polymerization through the solution polymerization are typified by azo polymerization initiators, peroxide polymerization initiators (e.g., dibenzoyl peroxide and tert-butyl permaleate), and redox polymerization initiators. Among them, azo polymerization initiators disclosed in JP-A No. 2002-69411 are preferred, which are typified by 2,2′-azobisisobutyronitrile, 2,2′-azobis-2-methylbutyronitrile, dimethyl 2,2′-azobis(2-methylpropionate), and 4,4′-azobis-4-cyanovaleric acid. Such azo polymerization initiators may be used in an amount of preferably 0.05 to 0.5 part by weight, and more preferably 0.1 to 0.3 part by weight, per 100 parts by weight of the total amount of the monomer component.

Crosslinking Agent

The pressure-sensitive adhesive composition may include a crosslinking agent. The crosslinking agent is not limited, but may be typified by isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Among them, isocyanate crosslinking agents and epoxy crosslinking agents are preferred.

Each of different crosslinking agents may be used alone or in combination.

The isocyanate crosslinking agents (multifunctional isocyanate compounds) include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, and hydrogenated xylene diisocyanate; and aromatic polyisocyanates such as 2,4-tolylene diisocyanate, 2,6-tolylene diisocyanate, 4,4′-diphenylmethane diisocyanate, and xylylene diisocyanate; as well as an adduct of tolylene diisocyanate with trimethylolpropane [trade name “CORONATE L”; Nippon Polyurethane Industry Co., Ltd.] and an adduct of hexamethylene diisocyanate with trimethylolpropane [trade name “CORONATE HL”; Nippon Polyurethane Industry Co., Ltd.].

The epoxy crosslinking agents (multifunctional epoxy compounds) are typified by N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, o-diglycidyl phthalate, triglycidyl tris(2-hydroxyethyl)isocyanurate, resorcinol diglycidyl ether, and bisphenol-S diglycidyl ether; as well as epoxy resins each having two or more epoxy groups per molecule. The epoxy crosslinking agents are also available as commercial products such as trade name “TETRAD C” from Mitsubishi Gas Chemical Company, Inc.

Though not critical, the pressure-sensitive adhesive composition may contain the crosslinking agent(s) in a content of preferably 0.001 to 10 parts by weight, and more preferably 0.01 to 3 parts by weight, per 100 parts by weight of the total amount of the monomer component. This may allow the pressure-sensitive adhesive composition to form a pressure-sensitive adhesive layer having a gel fraction controlled within a preferred range.

Solvent

The pressure-sensitive adhesive composition may contain a solvent. The solvent is not limited, but is typified by organic solvents including esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methyl ethyl ketone and methyl isobutyl ketone.

Each of different solvents may be used alone or in combination.

Other Additives

The pressure-sensitive adhesive composition may contain any of known additives (other additives) according to necessity, within ranges not adversely affecting advantageous effects of the present invention. Such other additives include cross-linking promoters, tackifier resins (e.g., rosin derivatives, polyterpene resins, petroleum resins, and oil-soluble phenols), age inhibitors, fillers, colorants (e.g., pigments and dyestuffs), ultraviolet absorbers, antioxidants, chain-transfer agents, plasticizers, softeners, surfactants, and antistatic agents.

The way to prepare the pressure-sensitive adhesive composition is not limited, but may be typified by a process of blending or mixing an acrylic polymer obtained through polymerization of a monomer component, or a partial polymer of the monomer component, and components added according to necessity (hereinafter also referred to as “optional components”) such as the polymerization initiators, solvents, and other additives.

Typically, a pressure-sensitive adhesive composition essentially including a partial polymer of the monomer component may be prepared by mixing a partial polymer of the monomer component, and optional components, such as the polymerization initiators, solvents, and other additives. A pressure-sensitive adhesive composition essentially including an acrylic polymer obtained through polymerization of the monomer component may be prepared typically by dissolving the acrylic polymer and optional components, such as the other additives, in a solvent.

The partial polymer of the monomer component may have a degree of polymerization of not critical, but preferably 5 to 20 percent by weight, and more preferably 5 to 15 percent by weight. This may help the pressure-sensitive adhesive composition to have a viscosity suitable for handling and coating.

A degree of polymerization of a partial polymer of the monomer component may be determined in the following manner.

A part of the partial polymer of the monomer component is sampled as a specimen. The specimen is weighed precisely to give a “weight of the partial polymer before drying.” Next, the specimen is dried at 130° C. for 2 hours, and the dried specimen is precisely weighed to give a “weight of the partial polymer after drying.” A weight loss of the specimen on drying at 130° C. for 2 hours is determined based on the “weight of the partial polymer before drying” and the “weight of the partial polymer after drying” and defined as a “weight loss” (volatile content; weight of unreacted monomers).

A degree of polymerization (percent by weight) of the partial polymer of the monomer component is determined from the “weight of the partial polymer before drying” and the “weight loss” according to the following equation:

Degree of polymerization (percent by weight) of partial polymer of monomer component=[1−(Weight loss)/(Weight of partial polymer before drying)]×100

The pressure-sensitive adhesive composition according to the present invention may be used as a pressure-sensitive adhesive composition to form a pressure-sensitive adhesive layer containing an acrylic polymer obtained through polymerization of the monomer component.

Pressure-Sensitive Adhesive Sheet

A pressure-sensitive adhesive sheet according to an embodiment of the present invention has superior reworkability at a low temperature. The pressure-sensitive adhesive sheet is advantageously usable typically as a pressure-sensitive adhesive sheet (removable pressure-sensitive adhesive sheet) which enables reuse of adherends after removal of the sheet therefrom, even after the adherends are once laminated to each other and then detached from each other.

Though not limited, the reworkability may be evaluated by the following delamination test.

Delamination Test

One adhesive face of a double-coated pressure-sensitive adhesive sheet (size: 26 mm long by 30 mm wide) is affixed to a surface of the following adherend A, and the other adhesive face is affixed to a surface of the following adherend B to yield a test piece having a structure of (adherend A)/(double-coated pressure-sensitive adhesive sheet)/(adherend B). Next, the test piece is placed in an autoclave, followed by autoclave treatment at a temperature of 50° C. and a pressure of 5 atmospheres for 15 minutes. The treated test piece is left stand at an ambient temperature of −30° C. for 30 minutes and subjected to a delamination test at an ambient temperature of −30° C., in which the adherend A is fixed and the adherend B is pulled in a thickness direction, to detach the adherend B from the adherend A. A maximum load upon detachment of the adherend B from the adherend A is measured and defined as an adhesive strength (N) at −30° C.

The adherend B may be detached at a tensile speed of preferably 10 to 1000 mm/min, and more preferably 100 to 500 mm/min. As used herein the term “thickness direction” refers to a direction perpendicular typically to a surface 100 mm long by 50 mm wide of the adherend A.

The adherend A is a glass plate (Matsunami Glass Ind., Ltd.; thickness: 0.7 mm, size: 100 mm long by 50 mm wide). The adherend B is a glass slide (Matsunami Glass Ind., Ltd.; thickness: 1.0 mm, size: 76 mm long by 26 mm wide). More specifically, the reworkability may be evaluated by a test according to the procedure described in “(5) reworkability” in after mentioned evaluations.

In an embodiment, the pressure-sensitive adhesive sheet is a double-coated pressure-sensitive adhesive sheet which allows the adherend A and the adherend B to be detached (delaminated) from each other in the delamination test. In a preferred embodiment, the pressure-sensitive adhesive sheet is a double-coated pressure-sensitive adhesive sheet which allows the adherend A and the adherend B to be detached from each other without fracture or breakage in the delamination test.

The double-coated pressure-sensitive adhesive sheet which allows the adherend A and the adherend B to be detached from each other without fracture in the delamination test may be a pressure-sensitive adhesive sheet having a pressure-sensitive adhesive layer formed from the pressure-sensitive adhesive composition according to the present invention, or a pressure-sensitive adhesive sheet not having a pressure-sensitive adhesive layer formed from the pressure-sensitive adhesive composition according to the present invention.

In another embodiment, the pressure-sensitive adhesive sheet is an optical double-coated pressure-sensitive adhesive sheet which has an adhesive strength at −30° C. of less than 20 N as measured in the delamination test and has a 180-degree peel strength at 23° C. of 2.0 N/20 mm or more on at least one adhesive face thereof as measured with respect to glass at a tensile speed of 300 mm/min.

Though not critical, a pressure-sensitive adhesive sheet according to an embodiment of the present invention (hereinafter also simply referred to as a “pressure-sensitive adhesive sheet”) may have a 180-degree peel strength (adhesive strength upon peeling at 180 degrees) at room temperature (23° C.) of preferably 2.0 N/20 mm or more (e.g., 2.0 to 50 N/20 mm), more preferably 2.5 N/20 mm or more (e.g., 2.5 to 40 N/20 mm), furthermore preferably 4.0 N/20 mm or more (e.g., 4.0 to 30 N/20 mm), and still more preferably 6.0 N/20 mm or more (e.g., 6.0 to 20 N/20 mm), as measured with respect to glass at a tensile speed of 300 mm/min and a temperature of 23° C. The pressure-sensitive adhesive sheet, when being a double-coated pressure-sensitive adhesive sheet, has a 180-degree peel strength at room temperature (23° C.) within the above-specified range preferably on at least one adhesive face, and more preferably on both adhesive faces thereof. The 180-degree peel strength may be measured typically by the procedure described in “(7) 180-degree peel strength” in the after-mentioned evaluations.

Though not critical, the pressure-sensitive adhesive sheet may have an adhesive strength at −30° C. of preferably less than 20 N (e.g., 3 N or more and less than 20 N), more preferably 18 N or less, and furthermore preferably 15 N or less, and particularly preferably less than 12 N (e.g., 5 N or more and less than 12 N). The pressure-sensitive adhesive sheet, when having an adhesive strength at −30° C. of less than 20 N, may have a lower adhesive strength to become easily removable from adherends at a low temperature (about −60° C. to about 20° C.). The pressure-sensitive adhesive sheet, when being a double-coated pressure-sensitive adhesive sheet, preferably has an adhesive strength at −30° C. within the above-specified range even when any of the two adhesive faces is applied to the adherend A.

The pressure-sensitive adhesive sheet is preferably, but is not limited to, a double-coated pressure-sensitive adhesive sheet having an adhesive strength at −30° C. of less than 20 N (e.g., 3 N or more and less than 20 N, more preferably 5 to 12 N) as measured in the delamination test and having a 180-degree peel strength at 23° C. of 2.0 N/20 mm or more (e.g., 2.0 to 50 N/20 mm, more preferably 2.5 to 40 N/20 mm, and furthermore preferably 4.0 to 30 N/20 mm) as measured with respect to glass at a tensile speed of 300 mm/min. Such double-coated pressure-sensitive adhesive sheet having a 180-degree peel strength at room temperature (23° C.) of 2.0 N/20 mm or more and an adhesive strength at −30° C. of less than 20 N may be a pressure-sensitive adhesive sheet having a pressure-sensitive adhesive layer formed from the pressure-sensitive adhesive composition according to the present invention, or a pressure-sensitive adhesive sheet not having a pressure-sensitive adhesive layer formed from the pressure-sensitive adhesive composition according to the present invention.

The pressure-sensitive adhesive sheet preferably has at least one pressure-sensitive adhesive layer formed from the pressure-sensitive adhesive composition according to the present invention (the layer is hereinafter also referred to as a “specific pressure-sensitive adhesive layer”).

The pressure-sensitive adhesive sheet may further have any of a substrate and a pressure-sensitive adhesive layer other than the specific pressure-sensitive adhesive layer, in addition to the specific pressure-sensitive adhesive layer. The pressure-sensitive adhesive sheet may further have any of other layers such as intermediate layers and under coats within ranges not adversely affecting advantageous effects of the present invention. The other layers than the specific pressure-sensitive adhesive layer may be provided in a number of one, or two or more.

As used herein the term “pressure-sensitive adhesive sheet” also includes a “pressure-sensitive adhesive tape.” Specifically, the pressure-sensitive adhesive sheet according to the present invention may be a pressure-sensitive adhesive tape in the form of a tape.

The pressure-sensitive adhesive sheet may be a single-coated pressure-sensitive adhesive sheet having a surface (adhesive face) of a pressure-sensitive adhesive layer (namely, a surface of a specific pressure-sensitive adhesive layer) as only one side thereof, or a double-coated pressure-sensitive adhesive sheet having surfaces of pressure-sensitive adhesive layers as both sides thereof. The pressure-sensitive adhesive sheet is preferably, but not limited to, a double-coated pressure-sensitive adhesive sheet and is more preferably a double-coated pressure-sensitive adhesive sheet having surfaces of a specific pressure-sensitive adhesive layer or layers as both sides thereof, for satisfactory lamination of adherends to each other.

The pressure-sensitive adhesive sheet may be a so-called “substrate-less” pressure-sensitive adhesive sheet, i.e., a pressure-sensitive adhesive sheet having no substrate (substrate layer) (hereinafter also referred to as a “substrate-less pressure-sensitive adhesive sheet”), or a pressure-sensitive adhesive sheet having a substrate. The substrate-less pressure-sensitive adhesive sheet is typified by double-coated pressure-sensitive adhesive sheets including a specific pressure-sensitive adhesive layer alone; and double-coated pressure-sensitive adhesive sheets including a specific pressure-sensitive adhesive layer and another pressure-sensitive adhesive layer than the specific pressure-sensitive adhesive layer (hereinafter also referred to as “other pressure-sensitive adhesive layer”). The pressure-sensitive adhesive sheet having a substrate is typified by single-coated pressure-sensitive adhesive sheets including a substrate and, on one side thereof, a specific pressure-sensitive adhesive layer; double-coated pressure-sensitive adhesive sheets including a substrate and, on both sides thereof, a specific pressure-sensitive adhesive layer; and double-coated pressure-sensitive adhesive sheets including a substrate, a specific pressure-sensitive adhesive layer on one side of the substrate, and another pressure-sensitive adhesive layer on the other side of the substrate.

Among them, substrate-less pressure-sensitive adhesive sheets are preferred, of which double-coated pressure-sensitive adhesive sheets having no substrate and including a specific pressure-sensitive adhesive layer alone are more preferred, for improvements in optical properties such as transparency. The pressure-sensitive adhesive sheet, when being a pressure-sensitive adhesive sheet having a substrate, is preferably, but not limited to, a double-coated pressure-sensitive adhesive sheet including a substrate and, on both sides thereof, a specific pressure-sensitive adhesive layer for satisfactory workability.

As used herein the term “substrate (substrate layer)” refers to a portion which is applied together with a pressure-sensitive adhesive layer to an adherend (e.g., optical member) when the pressure-sensitive adhesive sheet is used for (applied to) the adherend and does not include a separator (release liner) which is removed upon use (application) of the pressure-sensitive adhesive sheet.

The substrate is not limited, but may be typified by plastic films, antireflection (AR) films, polarizing plates, retardation films, and other optical films. Exemplary materials for the plastic films and other films include plastic materials which are typified by polyethylene terephthalate)s (PETs) and other polyester resins, poly(methyl methacrylate)s (PMMAs) and other acrylic resins, polycarbonates, triacetylcelluloses (TACs), polysulfones, polyarylates, polyimides, poly(vinyl chloride)s, poly(vinyl acetates, polyethylenes, polypropylenes, ethylene-propylene copolymers, trade name “ARTON (cyclic olefinic polymer; JSR),” trade name “ZEONOR (cyclic olefinic polymer; ZEON CORPORATION),” and other cyclic olefinic polymers. Each of different plastic materials may be used alone or in combination.

Of such substrates, a transparent substrate is preferred. As used herein the term “transparent substrate” refers to a substrate having a high total luminous transmittance at wavelengths in the visible light region of preferably 85% or more, and more preferably 88% or more, as determined in conformance with Japanese Industrial Standard (JIS) K 7361-1. The substrate may have a haze of preferably 1.5% or less, and more preferably 1.0% or less as determined in conformance with JIS K 7136. The transparent substrate may be typified by PET films; and non-oriented films such as films made from trade name “ARTON” and trade name “ZEONOR.”

Though not critical, the substrate may have a thickness of preferably 12 to 75 μm. The substrate may have a single-layer structure or multilayer structure. The substrate may have undergone, on its surface, a known or customary surface treatment which is typified by physical treatments such as corona discharge treatment, and plasma treatment; and chemical treatments such as primer coating.

The specific pressure-sensitive adhesive layer essentially includes an acrylic polymer obtained through polymerization of a monomer component. Though not critical, the specific pressure-sensitive adhesive layer may include the acrylic polymer in a content of 50 percent by weight or more, more preferably 60 percent by weight or more, and furthermore preferably 80 percent by weight or more, based on the total weight (100 percent by weight) of the specific pressure-sensitive adhesive layer. Within this range, the specific pressure-sensitive adhesive layer may excel in reworkability, bump absorptivity, and less-corroding property.

Though not critical, the specific pressure-sensitive adhesive layer may have a thickness of preferably 10 μm to 1 mm, more preferably 100 to 500 μm, and furthermore preferably 150 to 350 μm. The specific pressure-sensitive adhesive layer, when having a thickness of 10 μm or more, may have better conformability to bumps and may exhibit better bump absorptivity. The specific pressure-sensitive adhesive layer, when having a thickness of 1 mm or less, may be resistant to deformation and may exhibit better workability.

Though not critical, the specific pressure-sensitive adhesive layer may have a gel fraction of preferably 20 to 90 percent by weight, more preferably 30 to 85 percent by weight, and furthermore preferably 40 to 80 percent by weight. The specific pressure-sensitive adhesive layer, when having a gel fraction of 90 percent by weight or less, may have somewhat small cohesive force, become more flexible, and have better conformability to bumps to exhibit better bump absorptivity. In contrast, the specific pressure-sensitive adhesive layer, if having a gel fraction of less than 20 percent by weight, may become excessively flexible to exhibit insufficient workability. This pressure-sensitive adhesive layer may often suffer from blisters and/or gaps in a high-temperature environment or a high-temperature and high-humidity environment to have insufficient blistering/separation resistance. The gel fraction may be controlled by the types and contents (amounts) of a multifunctional monomer and/or a crosslinking agent.

The gel fraction (percentage of solvent-insoluble matter) may be determined as a percentage of ethyl-acetate-insoluble matter. Specifically, the gel fraction may be determined by immersing a sample specific pressure-sensitive adhesive layer in ethyl acetate at room temperature (23° C.) for 7 days, determining a weight fraction (unit: percent by weight) of the resulting insoluble matter based on the weight of the sample before immersion, and defining this as a gel fraction. More specifically, the term “gel fraction” herein refers to a value determined according to the following “method for gel fraction measurement.”

Method for Gel Fraction Measurement

About one gram of a pressure-sensitive adhesive layer is sampled to give a specimen, the specimen is weighed, and the measured weight is defined as a “weight of the pressure-sensitive adhesive layer before immersion.” Next, the pressure-sensitive adhesive layer specimen is immersed in 40 g of ethyl acetate for 7 days, all components (insoluble matter) insoluble in ethyl acetate are collected, the collected entire insoluble matter is dried at 130° C. for 2 hours to remove ethyl acetate, the dried insoluble matter is weighed, and the measured weight is defined as a “dry weight of insoluble matter” (weight of the pressure-sensitive adhesive layer after immersion). A gel fraction is determined by substituting the determined values in the following equation:

Gel fraction (percent by weight)=[(Dry weight of insoluble matter)/(Weight of pressure-sensitive adhesive layer before immersion)]×100

The specific pressure-sensitive adhesive layer may have a weight-average molecular weight of a solvent-soluble fraction (sol fraction) of not critical, but preferably 1.0×10⁵ to 5.0×10⁶, more preferably 2.0×10⁵ to 2.0×10⁶, and furthermore preferably 3.0×10⁵ to 1.0×10⁶. The specific pressure-sensitive adhesive layer, if having a weight-average molecular weight of the sol fraction of less than 1.0×10⁵, may have an insufficient adhesive strength. The specific pressure-sensitive adhesive layer, if having a weight-average molecular weight of the sol fraction of more than 5.0×10⁶, may have an excessively high modulus of elasticity to have an insufficient adhesive strength.

The “weight-average molecular weight of the solvent-soluble fraction (sol fraction)” may be determined according to the following measurement method.

Method for Measurement of Weight-average Molecular Weight of Solvent-Soluble Fraction (Sol Fraction)

About one gram of the specific pressure-sensitive adhesive layer is sampled to give a specimen, and the specimen is covered with a porous tetrafluoroethylene sheet having an average pore size of 0.2 μm (trade name “NTF1122,” Nitto Denko Corporation), and tied with a kite string. The resulting entire article is hereinafter referred to as a “sample.” Next, the sample is placed in 50 ml of ethyl acetate filling in a 50-ml vessel and left stand at 23° C. for one week (7 days). An ethyl acetate solution (including extracted sol fraction) is recovered from the vessel, dried under reduced pressure to volatilize the solvent (ethyl acetate), and thereby yields a sol fraction.

The sol fraction is dissolved in tetrahydrofuran (THF), and a weight-average molecular weight (Mw) of the sol fraction is measured through gel permeation chromatography (GPC) in terms of a polystyrene standard using a GPC analyzer, trade name “HLC-8120GPC” (Tosoh Corporation), under the following measurement conditions.

GPC Measurement Conditions

Sample concentration: 0.2 percent by weight

(tetrahydrofuran Solution)

Sample volume: 10 μl

Eluent: tetrahydrofuran (THF)

Flow rate: 0.6 mL/min

Column temperature (measurement temperature): 40° C.

Column: trade name “TSKgelSuperHM-H/H4000/H3000/H2000” (Tosoh Corporation)

Detector: differential refractive index detector (RI)

The specific pressure-sensitive adhesive layer may have a melting point not critical, but preferably −60° C. to 20° C., more preferably −40° C. to 10° C., and furthermore preferably −30° C. to 0° C. The specific pressure-sensitive adhesive layer, if having a melting point of higher than 20° C., may not exhibit a sufficient adhesive strength at room temperature.

Though not limited, the melting point may be measured typically by differential scanning calorimetry (DSC) in conformance with JIS K 7121 using the specific pressure-sensitive adhesive layer as a testing sample. Specifically, the melting point may be measured using a device “Q-2000” (TA Instruments) as a measuring instrument at temperatures rising from −80° C. to 80° C. at a rate of temperature rise of 10° C./min. More specifically, the melting point may be measured according to a procedure described in “(6) melting point” in the after-mentioned evaluations.

In addition to a specific pressure-sensitive adhesive layer, the pressure-sensitive adhesive sheet according to the present invention may further include a substrate, another pressure-sensitive adhesive layer (other pressure-sensitive adhesive layer) than the specific pressure-sensitive adhesive layer, and any of other layers (e.g., intermediate layers and under coats) within ranges not adversely affecting advantageous effects of the present invention.

The other pressure-sensitive adhesive layer (pressure-sensitive adhesive layer other than the specific pressure-sensitive adhesive layer) is not limited, but may be typified by known or customary pressure-sensitive adhesive layers respectively formed from known pressure-sensitive adhesives such as urethane pressure-sensitive adhesives, acrylic pressure-sensitive adhesives, rubber pressure-sensitive adhesives, silicone pressure-sensitive adhesives, polyester pressure-sensitive adhesives, polyamide pressure-sensitive adhesives, epoxy pressure-sensitive adhesives, vinyl alkyl ether pressure-sensitive adhesives, and fluorochemical pressure-sensitive adhesives. Each of different pressure-sensitive adhesives may be used alone or in combination.

A surface of a pressure-sensitive adhesive layer (adhesive face) of the pressure-sensitive adhesive sheet may be protected by a separator (release liner) before use. When the pressure-sensitive adhesive sheet is a double-coated pressure-sensitive adhesive sheet, two adhesive faces thereof may be protected by two separators respectively, or may be protected by one separator having release surfaces as both sides, where the sheet and the separator placed thereon are together wound to form a roll. The separator serves as a protector for a pressure-sensitive adhesive layer and will be removed when the pressure-sensitive adhesive sheet is applied to an adherend. The separator also serves as a support for the pressure-sensitive adhesive layer. Such separator does not always have to be provided.

The separator may employ a customary release paper, is not limited, but may be typified by base materials having a release agent layer; low-adhesive base materials including a fluorocarbon polymer; and low-adhesive base materials including a nonpolar polymer. The base materials having a release agent layer are exemplified by plastic films and papers whose surface has been treated with a releasing agent such as silicone release agents, long-chain alkyl release agents, fluorocarbon release agents, and molybdenum sulfide release agents. The fluorocarbon polymer is typified by polytetrafluoroethylenes, polychlorotrifluoroethylenes, poly(vinyl fluoride)s, poly(vinylidene fluoride)s, tetrafluoroethylene-hexafluoropropylene copolymers, and chlorofluoroethylene-vinylidene fluoride copolymers. The nonpolar polymer is typified by olefinic resins such as polyethylenes and polypropylenes. The separator may be formed according to a known or customary procedure. The separator is not limited typically in thickness.

The pressure-sensitive adhesive sheet may be produced according to a known or customary process. A way to produce the pressure-sensitive adhesive sheet may differ depending typically on the formulation of the pressure-sensitive adhesive composition, is not limited, but may be typified by following processes (1) to (3):

(1) A process of applying the pressure-sensitive adhesive composition according to the present invention to a substrate or separator, and curing the applied composition to give a pressure-sensitive adhesive sheet, in which the pressure-sensitive adhesive composition includes a partial polymer of the monomer component and other optional components such as a polymerization initiator, a solvent, a crosslinking agent, and other additives, and the curing may be performed typically through the application of heat or an active energy ray such as an ultraviolet ray;

(2) A process of applying a pressure-sensitive adhesive composition (solution) to a substrate or separator, and drying and/or curing the applied composition to give a pressure-sensitive adhesive sheet, in which the pressure-sensitive adhesive composition is a solution of the acrylic polymer and optional components such as a crosslinking agent and other additives dissolved in a solvent;

(3) A process of further drying the pressure-sensitive adhesive sheet produced in Process (1).

When a production process employs curing with an active energy ray (photocuring), the photocuring is preferably performed with blocking of oxygen typically by laminating a separator to the pressure-sensitive adhesive layer or by performing photocuring under a nitrogen atmosphere, because such photopolymerization reaction is inhibited by oxygen in the atmosphere (air).

The application (coating) in the production process of the pressure-sensitive adhesive sheet according to the present invention may employ a known coating procedure and may use any of customary coaters such as rotogravure roll coaters, reverse roll coaters, kiss-contact roll coaters, dip roll coaters, bar coaters, knife coaters, spray coaters, comma coaters, and direct coaters.

Though not limited, the pressure-sensitive adhesive sheet is preferably produced from a pressure-sensitive adhesive composition containing a partial polymer of the monomer component and a polymerization initiator (such as a photoinitiator or thermal initiator) through a curing reaction by the action of heat or an active energy ray. This may provide satisfactory productivity. The pressure-sensitive adhesive sheet is also preferably produced from a pressure-sensitive adhesive composition containing a photoinitiator through a curing reaction by the action of an active energy ray. This may give a pressure-sensitive adhesive layer having a large thickness.

The pressure-sensitive adhesive sheet may have a thickness (total thickness) of not critical, but preferably 10 μm to 1 mm, more preferably 100 to 500 μm, and furthermore preferably 150 to 350 μm. The pressure-sensitive adhesive sheet, when having a thickness of 10 μm or more, may allow the specific pressure-sensitive adhesive layer to conform to bumps more satisfactorily to thereby exhibit better bump absorptivity. As used herein the term “thickness” of the pressure-sensitive adhesive sheet refers to a thickness (distance) from one adhesive face to the other adhesive face of the pressure-sensitive adhesive sheet. The “thickness” of the pressure-sensitive adhesive sheet does not include the thickness of a separator or separators.

The pressure-sensitive adhesive sheet preferably has high transparency. The pressure-sensitive adhesive sheet has a haze of preferably 2% or less, and more preferably 1% or less, as measured in conformance with JIS K 7136. The pressure-sensitive adhesive sheet, when having a haze of 2% or less, may allow an adherend optical product or optical member to have satisfactory transparency and a good appearance even after the sheet is applied thereto.

Though not critical, the pressure-sensitive adhesive sheet may have a total luminous transmittance of preferably 85% or more, and more preferably 90% or more. The total luminous transmittance is a total luminous transmittance at wavelengths in the visible light region as measured in conformance with JIS K 7361-1. The pressure-sensitive adhesive sheet, when having a total luminous transmittance of 85% or more, may allow an optical product or optical member to have satisfactory transparency and a good appearance even after the sheet is applied thereto.

The haze and total luminous transmittance may be measured with a hazemeter typically after laminating the pressure-sensitive adhesive sheet to a glass plate. Specifically, the haze and total luminous transmittance may be measured according to a procedure described in “(2) haze and total luminous transmittance” in the after-mentioned evaluations.

The pressure-sensitive adhesive sheet has satisfactory reworkability. For this reason, when the pressure-sensitive adhesive sheet is used for the lamination of highly rigid adherends (e.g., glass products) to each other, the adherends can be detached (delaminated) from each other without fracture or breakage by placing the adherends with the sheet in an environment of low temperatures (about −60° C. to about 20° C.).

The pressure-sensitive adhesive sheet may be advantageously used for optical use, joining use (bonding use), and protection use, although the usage thereof is not limited. Above all, the pressure-sensitive adhesive sheet is particularly advantageously usable for optical use. More specifically, the pressure-sensitive adhesive sheet is advantageously usable as an optical pressure-sensitive adhesive sheet which is used typically for the lamination of optical members (for optical member lamination) and for the production of products (optical products) using optical members.

The optical members are not limited, as long as being members having any of optical properties (e.g., polarizability, photorefractivity, light scattering, light reflectivity, optical transparency, optical absorptivity, optical diffractive ability, optical rotatory power, and visibility), but may be typified by members constituting or being applied to optical products such as display devices (image display devices) and input devices. Specifically, Exemplary optical members include polarizing plates, wave plates, retardation films, compensation films, brightness enhancing films, light guide panels, reflective films, antireflection films, transparent conductive films (e.g., ITO films), films with graphical design function, decorative films, surface-protective sheets, prisms, lenses, color filters, and transparent substrates; and members as assemblies of them.

The display devices (image display devices) are exemplified by liquid crystal display devices, organic electroluminescence (EL) display devices, plasma display panels (PDPs), and electronic papers. The input devices are typified by touch-screen panels.

The optical members are not limited in material and shape, but may be typified by members made from materials such as glass, acrylic resins, polycarbonates, poly(ethylene terephthalate)s, and thin metal films. These may be in the form of a sheet, film, or plate. As used herein the term “optical member” also includes members playing the function of decoration or protection of an adherend display device or input device with maintaining the visibility of the adherend, which are typified by films with graphical design function, decorative films, and surface-protective sheets.

The pressure-sensitive adhesive sheet is preferably used for the lamination of a highly rigid optical member or members, and particularly preferably for the lamination of a glass optical member or members. Specifically, the pressure-sensitive adhesive sheet is desirably an optical pressure-sensitive adhesive sheet for the lamination of an optical member or members made of glass, such as glass sensors, glass display panels (e.g., liquid crystal displays (LCDs)), glass plates, and transparent electrodes in touch-screen panels; and is more preferably an optical pressure-sensitive adhesive sheet for the lamination of a glass sensor to a glass display panel.

A method for detaching members (e.g., optical members) laminated by the medium of the pressure-sensitive adhesive sheet is not limited but may be typified by a detaching method by pulling laminated two members in a thickness direction, i.e., a detaching method by pulling the two members in a direction perpendicular to the bonding planes between the pressure-sensitive adhesive sheet and the members; a detaching method by relatively translating the two members; and a detaching method by moving at least one of the two members so that virtual straight lines become in a torsional alignment, where the virtual straight lines are specified in a bonding plane between the pressure-sensitive adhesive sheet and one of the two members and in a bonding plane between the sheet and the other member and are in parallel with each other, i.e., a detaching method by moving at least one of the two members so that one adhesive face becomes distorted with respect to the other adhesive face.

As used herein the phrase “relatively translating the two members” refers to movement of at least one of two members which have been laminated to each other by the medium of the pressure-sensitive adhesive sheet, so that space between surfaces of the two members facing each other is maintained substantially constant. Typically when the two members are flat-plate members, the phrase refers to movement of at least one of the two members so that the two members (flat plates) are maintained in parallel with each other.

When two members are laminated to each other by the medium of the pressure-sensitive adhesive sheet and even when at least one of the two members is one having a small thickness and having low flexibility, the detaching method enables detachment of the two members without substantially applying such force (load) on the members as to cause a large distortion (deformation) leading to fracture or breakage. Though not limited, the detaching method is preferably used for the detachment of laminated optical members, more preferably used for the detachment of laminated optical members made of glass, such as glass sensors, glass display panels (e.g., LCDs), and glass plates with transparent electrodes in touch-screen panels, and furthermore preferably used for the detachment of a laminate including a glass sensor and a glass display panel.

### EXAMPLES

The present invention will be illustrated in further detail with reference to several working examples below. It should be noted, however, that these examples are never construed to limit the scope of the present invention. Formulations (types and amounts of monomers to be used) of monomers constituting a monomer component are indicated in Table 1.

### Example 1

A mixture of 98 parts by weight of lauryl acrylate (LA) and 2 parts by weight of N-vinyl-2-pyrrolidone (NVP) was placed in a four-necked flask, combined with photoinitiators, i.e., 0.05 part by weight of 1-hydroxycyclohexyl phenyl ketone (trade name “IRGACURE 184,” BASF JAPAN LTD.) and 0.05 part by weight of 2,2-dimethoxy-1,2-diphenylethan-1-one (trade name “IRGACURE 651,” BASF JAPAN LTD.), irradiated with an ultraviolet ray under a nitrogen atmosphere for photopolymerization so as to have a viscosity of about 15 Pa·s, and thereby yielded a partially polymerized monomer syrup (partial polymer of a monomer component). The viscosity was measured with a BH type rotational viscometer using a No. 5 rotor at a rate of 10 rpm, at a temperature of 30° C.

The partially polymerized monomer syrup (100 parts by weight) was uniformly mixed with 0.04 part by weight of 1,6-hexanediol diacrylate (HDDA; multifunctional monomer) and photoinitiators (additional polymerization initiators), i.e., 0.05 part by weight of 1-hydroxycyclohexyl phenyl ketone (trade name “IRGACURE 184,” BASF JAPAN LTD.) and 0.05 part by weight of 2,2-dimethoxy-1,2-diphenylethan-1-one (trade name “IRGACURE 651,” BASF JAPAN LTD.) and yielded a pressure-sensitive adhesive composition.

The pressure-sensitive adhesive composition was applied to a releasably-treated surface of a release film (“MRF #38,” Mitsubishi Plastics, Inc.) to a thickness of 175 μm to form a pressure-sensitive adhesive layer thereon. Next, an exposed surface (the other surface) of the pressure-sensitive adhesive layer was laminated to a releasably-treated surface of a release film (“MRN #38,” Mitsubishi Plastics, Inc.), the resulting article was irradiated with an ultraviolet ray at an intensity of 4 mW/cm² and a dose (light quantity) of 1200 mJ/cm² to photocure the pressure-sensitive adhesive layer, and yielded a pressure-sensitive adhesive sheet.

### Example 2 to 13 and Comparative Example 1

Pressure-sensitive adhesive compositions and pressure-sensitive adhesive sheets were prepared by the procedure of Example 1, except for using monomers of different types in different amounts for constituting a monomer component.

Evaluations

The pressure-sensitive adhesive compositions and pressure-sensitive adhesive sheets obtained in Examples 1 to 13 and Comparative Example 1 were examined and evaluated on gel fraction, haze and total luminous transmittance, blistering resistance reliability, bump absorptivity, reworkability, melting point, and 180-degree peel strength. Evaluation methods are as follows. The evaluation results are indicated in Table 1.

(1) Gel Fraction

A gel fraction was measured according to the aforementioned “method for gel fraction measurement.”

(2) Haze and Total Luminous Transmittance

One release film (MRN #38) was removed from each of the pressure-sensitive adhesive sheets prepared in Examples 1 to 13 and Comparative Example 1 to expose an adhesive face, and the exposed adhesive face of the pressure-sensitive adhesive sheet was applied to a glass plate (trade name “Slide Glass S111,” Matsunami Glass Ind., Ltd., having a thickness of 1.0 mm and a haze of 0.1%), and the other release film was removed, to give a test piece. The test piece was subjected to measurements of haze (%) and total luminous transmittance (%) in conformance with JIS K 7136 and JIS K 7361-1, respectively, using a hazemeter (device name “HM-150,” Murakami Color Research Laboratory).

(3) Blistering Resistance Reliability

Sheet specimens 100 mm long by 50 mm wide (sheet specimens of 100 mm by 50 mm) were cut from the pressure-sensitive adhesive sheets prepared in Examples 1 to 13 and Comparative Example 1, and one release film (MRN #38) was removed therefrom to expose one adhesive face.

Next, a glass plate (cut soda-lime glass plate, Matsunami Glass Ind., Ltd., 100 mm long by 50 mm wide by 0.7 mm thick) was laminated to a polarizing plate (Nitto Denko Corporation, 100 mm long by 50 mm wide by 0.5 mm thick) to give a glass laminate. The sheet specimens were affixed to the glass laminate so that the exposed adhesive face (pressure-sensitive adhesive layer) was in contact with the polarizing plate.

Next, the other release film (MRF #38) was removed from the sheet specimens to expose the other adhesive face, and the exposed adhesive face was affixed to a glass plate (cut soda-lime glass plate, Matsunami Glass Ind., Ltd., 100 mm long by 50 mm wide by 0.7 mm thick) under the following conditions. Thus, evaluation samples having a structure of (glass plate)/(pressure-sensitive adhesive sheet)/(polarizing plate)/(glass plate) were obtained.

Affixation Conditions

Contact pressure: 0.1 MPa

Degree of vacuum: 30 Pa

Affixation time: 17 seconds

Next, the evaluation samples were placed in an autoclave, followed by autoclave treatment at a temperature of 50° C. and a pressure of 5 atmospheres for 15 minutes. The evaluation samples after the autoclave treatment were retrieved from the autoclave, placed in a dryer at a preset temperature of 85° C., and left stand for 24 hours. After 24-hours standing, the evaluation samples were retrieved from the dryer and left stand at room temperature (23° C.) for 30 minutes. The evaluation samples were visually observed to determine whether blisters or bubbles are present between the polarizing plate and the pressure-sensitive adhesive sheet, and between the glass plate and the pressure-sensitive adhesive sheet. A sample bearing no bubble was evaluated as having very good blistering resistance reliability (VG); a sample bearing less than five bubbles was evaluated as having good blistering resistance reliability (G); and a sample bearing five or more bubbles was evaluated as having poor blistering resistance reliability (Failure; F).

(4) Bump Absorptivity

Sheet specimens 100 mm long and 50 mm wide (sheet specimens of 100 mm by 50 mm) were cut from the pressure-sensitive adhesive sheets prepared in Examples 1 to 13 and Comparative Example 1, and one release film (MRN #38) was removed from each sheet specimen to expose one adhesive face.

Next, the exposed adhesive face of each sheet specimen was affixed to a glass plate (cut soda-lime glass plate, Matsunami Glass Ind., Ltd., 100 mm long, 50 mm wide, and 0.7 mm thick).

Next, the other separator (release film) (MRF #38) was removed from each sheet specimen affixed to the glass plate to expose the other adhesive face, and the exposed adhesive face was affixed to a plate glass bearing printed-ink bumps under the following conditions so that the exposed adhesive face (pressure-sensitive adhesive layer) was in contact with the printed-ink bumped surface of the glass plate. Thus, evaluation samples having a structure of (glass plate)/(pressure-sensitive adhesive sheet)/(glass plate with printed-ink bumps) were obtained.

Affixation Conditions

Contact pressure: 0.1 MPa

Degree of vacuum: 30 Pa

Affixation time: 17 seconds

The glass plate with printed-ink bumps is a glass plate (Matsunami Glass Ind., Ltd., 100 mm long, 50 mm wide, 0.7 mm thick) which has been subjected to printing to form a printed portion with a thickness (height of printed-ink bumps) of 35 μm.

Next, the evaluation samples were placed in an autoclave, followed by autoclave treatment at a temperature of 50° C. and a pressure of 5 atmospheres for 15 minutes. The evaluation samples after the autoclave treatment were retrieved from the autoclave, and how the pressure-sensitive adhesive layer and the glass plate with printed-ink bumps are affixed to each other was visually observed. A sample not suffering from a gap between the pressure-sensitive adhesive layer and the glass plate with printed-ink bumps was evaluated as having good bump absorptivity (G); and a sample suffering from a gap therebetween was evaluated as having poor bump absorptivity (Failure; F).

(5) Reworkability

Preparation of Test Samples

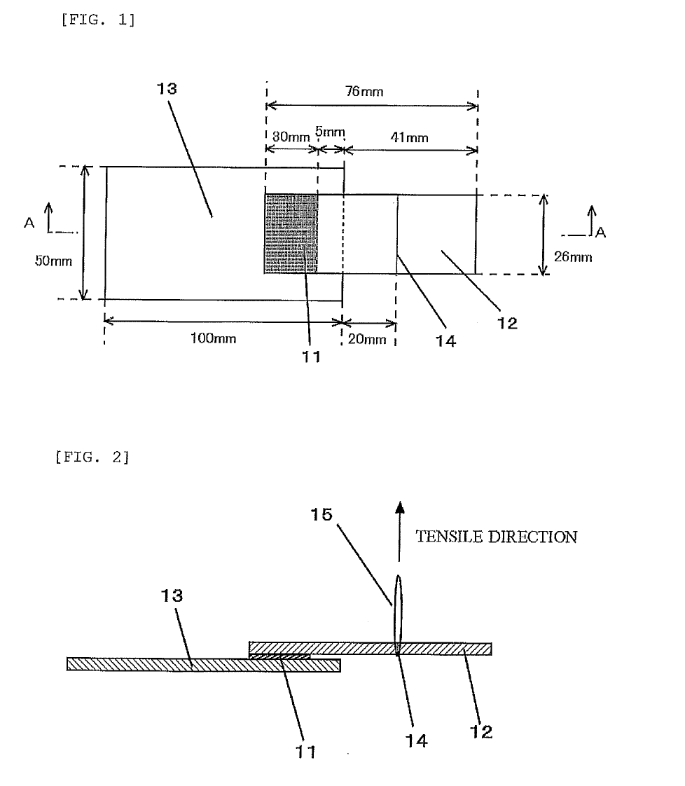

FIG. 1 is an explanatory drawing (plan view) illustrating a test sample used for the evaluation of reworkability. FIG. 2 is an explanatory drawing (cross-sectional view taken along the line A-A in FIG. 1) illustrating the test sample on which a kite string is hooked.

Sheet specimens (size: 30 mm long by 26 mm wide) were cut from the pressure-sensitive adhesive sheets prepared in Examples 1 to 13 and Comparative Example 1 and subjected as a sheet specimen 11 to measurements after removal of the release films therefrom.

A glass slide (a) 12 (size: 76 mm long by 26 mm wide by 1.0 mm thick) and a glass plate (b) 13 (size: 100 mm long by 50 mm wide by 0.7 mm thick) were laminated to each other through the sheet specimen 11 in the following manner to yield test samples as illustrated in FIGS. 1 and 2. The glass slide (a) has a kite-string-pulling part 14 extending in a width direction at a position of 55 mm from the laminated end.

Specifically, one release film (MRN #38) was removed from the cut sheet specimen to expose one adhesive face, the exposed adhesive face was applied to the glass slide (a) 12; whereas the other release film (MRF #38) was removed to expose the other adhesive face, and the exposed adhesive face was applied to the glass plate (b) 13. Thus, test samples having a structure of (glass slide (a))/(pressure-sensitive adhesive sheet)/(glass plate (b)) were obtained.

Evaluation of Reworkability at −30° C. and Adhesive Strength (N) at −30° C.

The test samples were placed in an autoclave, followed by autoclave treatment at a temperature of 50° C. and a pressure of 5 atmospheres for 15 minutes. The test samples after the autoclave treatment were retrieved from the autoclave and left stand at a temperature of −30° C. for 30 minutes. Next, a kite string 15 was hooked on the glass slide (a) 12 at the kite-string-pulling part 14 as illustrated in FIGS. 1 and 2. The glass plate (b) 13 was fixed to a tensile tester using a metal jig, and the kite string 15 was pulled in a direction perpendicular to the surface of the glass plate (b) 13 (tensile direction in FIG. 2) using the tensile tester at a temperature of −30° C. and at a tensile speed of 300 mm/min to detach the glass slide (a) and the glass plate (b) from each other. How the glass slide (a) and the glass plate (b) after detachment were was visually observed, and reworkability was evaluated according to criteria below.

In this process, a maximum load upon detachment of the glass slide (a) and the glass plate (b) from each other was measured and defined as an “adhesive strength (N) at −30° C.” When the glass slide (a) was broken, a load upon the breakage was defined as an “adhesive strength (N) at −30° C.”

A sample enabling detachment of the glass slide (a) and the glass plate (b) from each other without breakage and having an adhesive strength (N) at −30° C. of 12 N or less was evaluated as having very good reworkability at −30° C. (VG); a sample enabling detachment of the glass slide (a) and the glass plate (b) from each other without breakage and having an adhesive strength (N) at −30° C. of less than 20 N was evaluated as having good reworkability at −30° C. (G); and a sample suffering from breakage of the glass slide (a) or the glass plate (b) was evaluated as having poor reworkability at −30° C. (Failure; F).

Evaluation of Reworkability at Room Temperature as Tackiness at Room Temperature

The test samples were placed in an autoclave, followed by autoclave treatment at a temperature of 50° C. and a pressure of 5 atmospheres for 15 minutes. The test samples after the autoclave treatment were retrieved from the autoclave and left stand at room temperature (23° C.) for 30 minutes. Next, a kite string 15 was hooked on the glass slide (a) 12 at the kite-string-pulling part 14 as illustrated in FIGS. 1 and 2. The glass plate (b) 13 was fixed to a tensile tester using a metal jig, and the kite string 15 was pulled in a direction perpendicular to the surface of the glass plate (b) 13 (tensile direction in FIG. 2) using the tensile tester at room temperature and at a tensile speed of 300 mm/min. A undergoing detachment of the glass slide (a) and the glass plate (b) without breakage was evaluated as having poor tackiness at room temperature (Failure; F); and a sample undergoing breakage of the glass slide (a) or the glass plate (b) was evaluated as having good tackiness at room temperature (G).

(6) Melting Point

Pressure-sensitive adhesive layers (each 2 to 3 mg) of the pressure-sensitive adhesive sheets prepared in Examples 1 to 13 and Comparative Example 1 were sampled, placed in an aluminum vessel, followed by crimping of the vessel, and thereby yielded test samples. The test samples were subjected to measurements with a differential scanning calorimeter (DSC) (measurement instrument: device name “Q-2000,” TA Instruments) in conformance with JIS K 7121 at temperatures rising from −80° C. to 80° C. at a rate of temperature rise of 10° C./min, and endothermic peak temperatures (Tm) of the test samples were determined and defined as melting points.

A sample whose melting point was not measured is indicated as “unmeasured (−),” and a sample not undergone crystallization with melting point being unmeasurable is indicated as “non-measurable (NM)” in Table 1.

(7) 180-Degree Peel Strength

Sheet specimens 100 mm long by 20 mm wide (sheet specimens of 100 mm by 20 mm) were cut from the pressure-sensitive adhesive sheets prepared in Examples 1 to 13 and Comparative Example 1, one release film (MRN #38) was removed therefrom to expose one adhesive face, and the exposed adhesive face (opposite side to a side to be measured) was lined with a PET film (“LUMIRROR S-10,” Toray Industries Inc., 50 μm thick) and thereby yielded strip sheet specimens.

Next, the other release film (MRF #38) was removed from each strip sheet specimen to expose the other adhesive face (side to be measured), and the exposed other adhesive face was affixed to a glass plate (Matsunami Glass Ind., Ltd., 0.7 mm thick) at an ambient temperature of 23° C. through compression bonding by a reciprocating movement of a 2-kg roller and thereby yielded measurement samples.

The measurement samples were left stand at an ambient temperature of 23° C. and 50% relative humidity for 30 minutes, and subjected to a 180-degree peel test using a tensile tester to measure a 180-degree peel strength (adhesive strength upon peeling at 180 degrees) (N/20 mm) with respect to the glass plate. The measurement was performed at an ambient temperature of 23° C. and 50% relative humidity, a peel angle of 180 degrees, and a tensile speed of 300 mm/min.

TABLE 1

| | | | | | | | | | | | | Com. | Ex. | Ex. | Ex. | Ex. |
|---|---|---|---|---|---|---|---|---|---|---|---|---|---|---|---|---|
| | | | Ex. 1 | Ex. 2 | Ex. 3 | Ex. 4 | Ex. 5 | Ex. 6 | Ex. 7 | Ex. 8 | Ex. 9 | Ex. 1 | 10 | 11 | 12 | 13 |
| Monomer | (Meth)acrylic C₁₀-C₁₃ | LA | 98 | 96 | 78.4 | 67.3 | 86.5 | 75.5 | 68.6 | 66 | 90 | | 90 | 75 | 80 | 75 |
| component | alkyl ester | | | | | | | | | | | | | | | |
| | (part by weight) | | | | | | | | | | | | | | | |
| | (Meth)acrylic C₁-C₉ | BA | | | 19.6 | 28.8 | | | | | | | | | | 10 |
| | alkyl ester | MA | | | | | 9.6 | 18.9 | 29.4 | 28 | | | | | | |
| | (part by weight) | 2EHA | | | | | | | | | | 90 | | | | |
| | Alicyclic monomer | IBXA | | | | | | | | | | | | 19 | 10 | 4 |
| | (part by weight) | | | | | | | | | | | | | | | |
| | Polar-group-containing | NVP | 2 | | | 4 | | 6 | | | | | | 6 | 10 | 6 |
| | monomer | NVC | | | | | | | | 6 | 10 | | | | | |
| | (part by weight) | DMAA | | 4 | | | | | 2 | | | | | | | |
| | | HEA | | | 2 | | 4 | | | | | | | | | |
| | Multifunctional monomer | HDDA | 0.04 | 0.04 | 0.04 | 0.04 | 0.04 | 0.04 | 0.06 | 0.03 | | | 0.05 | 0.04 | 0.04 | 0.04 |
| | (part by weight) | DPHA | | | | | | | | | | 0.07 | | | | |
| | Carboxyl-containing | AA | | | | | | | | | | 10 | 10 | | | |
| | monomer | | | | | | | | | | | | | | | |
| | (part by weight) | | | | | | | | | | | | | | | |

| | | | | | | | | | | | | | | |
|---|---|---|---|---|---|---|---|---|---|---|---|---|---|---|
| Gel fraction (%) | 44.8 | 39.8 | 38.0 | 48.9 | 56.6 | 52.0 | 56.2 | 45.6 | 50.5 | 65.0 | 83.3 | 68.3 | 72.0 | 66.0 |
| Haze (%) | 0.2 | 0.5 | 0.2 | 0.4 | 0.4 | 0.3 | 0.3 | 0.3 | 0.3 | 0.3 | 1.3 | 0.3 | 0.4 | 0.3 |
| Total light transmittance (%) | 92.4 | 92.4 | 92.4 | 92.5 | 92.3 | 92.4 | 92.4 | 92.5 | 92.5 | 92.5 | 92.4 | 91.9 | 91.9 | 92.0 |
| Blistering resistance reliability | G | G | VG | VG | VG | VG | G | VG | VG | VG | VG | VG | G | G |
| Bump absorptivity | G | G | G | G | G | G | G | G | G | F | F | G | G | G |
| Reworkability at −30° C. | VG | VG | G | G | G | VG | VG | G | VG | F | VG | G | VG | VG |
| Adhesive strength (N) at −30° C. | 6.5 | 6.9 | 12.8 | 16.3 | 17.0 | 10.5 | 6.8 | 16.5 | 9.3 | 20.0 | 10.8 | 19.3 | 11.3 | 7.3 |
| Tackiness at room temperature | G | G | G | G | G | G | G | G | G | G | G | G | G | G |
| Melting point (° C.) | −1 | −3 | −10 | −13 | −6 | −11 | −14 | −18 | — | NM | — | −18 | −14 | −16 |
| 180-Degree peel strength (N/20 mm) | 3.6 | 4.5 | 9.0 | 5.2 | 5.5 | 6.7 | 8.0 | 13.8 | 2.7 | 24.8 | 14.5 | 8.2 | 6.1 | 7.7 |

Monomer components are abbreviated as follows in Table 1.
LA: Lauryl acrylate
BA: Butyl acrylate
MA: Methyl acrylate
2EHA: 2-Ethylhexyl acrylate
IBXA: Isobornyl acrylate
NVP: N-Vinyl-2-pyrrolidone
DMAA: N,N-Dimethylacrylamide
NVC: N-Vinylcaprolactam
HEA: 2-Hydroxyethyl acrylate
HDDA: 1,6-Hexanediol diacrylate
DPHA: Dipentaerythritol hexaacrylate
AA: Acrylic acid

The results in Table 1 demonstrate as follows. The pressure-sensitive adhesive sheets according to Example 1 to 13 were superior to the pressure-sensitive adhesive sheet according to Comparative Example 1 in properties such as reworkability at −30° C. and 180-degree peel strength at 23° C. The pressure-sensitive adhesive sheet according to Comparative Example 1 had no pressure-sensitive adhesive layer formed from a pressure-sensitive adhesive composition including an acrylic polymer obtained through polymerization of a monomer component containing a (meth)acrylic C₁₀-C₁₃ alkyl ester. Among the pressure-sensitive adhesive sheets according to the examples, those according to Examples 1 to 9 and 11 to 13 also had satisfactory bump absorptivity.

### REFERENCE SIGNS LIST

11 sheet specimen (pressure-sensitive adhesive sheet)
12 glass slide (a)
13 glass plate (b)
14 kite-string-pulling part
15 kite string

While preferred embodiments of the present invention have been described using specific terms, such description is for illustrating purposes only, and it is to be understood that various changes and modifications may be made without departing from the spirit and scope of the present invention as defined in the appended claims.

1. A pressure-sensitive adhesive composition comprising an acrylic polymer formed from a monomer component through polymerization, or a partial polymer of the monomer component,
wherein the monomer component comprises a (meth)acrylic alkyl ester whose alkyl moiety being a linear or branched-chain alkyl group having 10 to 13 carbon atoms, and the monomer component comprises substantially no carboxyl-containing monomer.

2. The pressure-sensitive adhesive composition of claim 1, wherein the monomer component further comprises a polar-group-containing monomer.

3. The pressure-sensitive adhesive composition of claim 2, wherein the polar-group-containing monomer comprises at least one selected from the group consisting of hydroxyl-containing monomers and nitrogen-containing monomers.

4. The pressure-sensitive adhesive composition of claim 1, wherein the monomer component further comprises a (meth)acrylic alkyl ester whose alkyl moiety being a linear or branched-chain alkyl group having 1 to 9 carbon atoms.

5. The pressure-sensitive adhesive composition of claim 1, wherein the monomer component further comprises a (meth)acrylic ester having an alicyclic hydrocarbon group.

6. The pressure-sensitive adhesive composition of claim 1, wherein the (meth)acrylic alkyl ester whose alkyl moiety being a linear or branched-chain alkyl group having 10 to 13 carbon atoms comprises lauryl acrylate.

7. A pressure-sensitive adhesive sheet comprising a pressure-sensitive adhesive layer derived from the pressure-sensitive adhesive composition of claim 1.

8. The pressure-sensitive adhesive sheet of claim 7, wherein the pressure-sensitive adhesive layer contains the acrylic polymer in a content of 50 percent by weight or more.

9. The pressure-sensitive adhesive sheet of claim 7, as an optical pressure-sensitive adhesive sheet.

10. An optical double-coated pressure-sensitive adhesive sheet having an adhesive strength at −30° C. of less than 20 N in a delamination test mentioned below and having a 180-degree peel strength at 23° C. of 2.0 N/20 mm or more on at least one adhesive face thereof, the 180-degree peel strength being determined with respect to glass at a tensile speed of 300 mm/min:
Delamination Test: One adhesive face of a double-coated pressure-sensitive adhesive sheet (size: 26 mm long by 30 mm wide) is affixed to a surface of an after-mentioned adherend A and the other adhesive face is affixed to a surface of an after-mentioned adherend B to give a test piece having a structure of (adherend A)/(double-coated pressure-sensitive adhesive sheet)/(adherend B); the test piece is treated at a temperature of 50° C. and a pressure of 5 atmospheres for 15 minutes and left stand at an ambient temperature of −30° C. for 30 minutes; while the adherend A is fixed, the adherend B is pulled in a thickness direction at a tensile speed of 300 mm/min; and a maximum load at which the adherend A and the adherend B are detached from each other is measured as the adhesive strength at −30° C.
Adherend A: Glass plate (Matsunami Glass Ind., Ltd., 0.7 mm thick, size: 100 mm long by 50 mm wide)
Adherend B: Glass slide (Matsunami Glass Ind., Ltd., 1.0 mm thick, size: 76 mm long by 26 mm wide).

11. A double-coated pressure-sensitive adhesive sheet allowing an adherend A and an adherend B mentioned below to be detached from each other without fracture or breakage in the following delamination test:
Delamination Test: One adhesive face of a double-coated pressure-sensitive adhesive sheet (size: 26 mm long by 30 mm wide) is affixed to a surface of the following adherend A and the other adhesive face is affixed to a surface of the following adherend B to give a test piece having a structure of (adherend A)/(double-coated pressure-sensitive adhesive sheet)/(adherend B); the test piece is treated at a temperature of 50° C. and a pressure of 5 atmospheres for 15 minutes and left stand at an ambient temperature of −30° C. for 30 minutes; while the adherend A is fixed, the adherend B is pulled in a thickness direction at a tensile speed of 300 mm/min; and a maximum load at which the adherend A and the adherend B are detached from each other is measured as the adhesive strength at −30° C.
Adherend A: Glass plate (Matsunami Glass Ind., Ltd., 0.7 mm thick, size: 100 mm long by 50 mm wide)
Adherend B: Glass slide (Matsunami Glass Ind., Ltd., 1.0 mm thick, size: 76 mm long by 26 mm wide).

12. The pressure-sensitive adhesive composition of claim 2, wherein the monomer component further comprises a (meth)acrylic alkyl ester whose alkyl moiety being a linear or branched-chain alkyl group having 1 to 9 carbon atoms.

13. The pressure-sensitive adhesive composition of claim 2, wherein the monomer component further comprises a (meth)acrylic ester having an alicyclic hydrocarbon group.

14. The pressure-sensitive adhesive composition of claim 2, wherein the (meth)acrylic alkyl ester whose alkyl moiety being a linear or branched-chain alkyl group having 10 to 13 carbon atoms comprises lauryl acrylate.

15. The pressure-sensitive adhesive composition of claim 3, wherein the monomer component further comprises a (meth)acrylic alkyl ester whose alkyl moiety being a linear or branched-chain alkyl group having 1 to 9 carbon atoms.

16. The pressure-sensitive adhesive composition of claim 3, wherein the monomer component further comprises a (meth)acrylic ester having an alicyclic hydrocarbon group.

17. The pressure-sensitive adhesive composition of claim 3, wherein the (meth)acrylic alkyl ester whose alkyl moiety being a linear or branched-chain alkyl group having 10 to 13 carbon atoms comprises lauryl acrylate.

18. The pressure-sensitive adhesive composition of claim 4, wherein the monomer component further comprises a (meth)acrylic ester having an alicyclic hydrocarbon group.

19. The pressure-sensitive adhesive composition of claim 4, wherein the (meth)acrylic alkyl ester whose alkyl moiety being a linear or branched-chain alkyl group having 10 to 13 carbon atoms comprises lauryl acrylate.

20. The pressure-sensitive adhesive composition of claim 5, wherein the (meth)acrylic alkyl ester whose alkyl moiety being a linear or branched-chain alkyl group having 10 to 13 carbon atoms comprises lauryl acrylate.
